(19) United States
(12) Patent Application Publication
(10) Pub. No.: US 2012/0058698 A1
(43) Pub. Date: Mar. 8, 2012

(54) SIZING COMPOSITION, GLASS STRAND, AND FABRIC

(75) Inventors: Tingdong Lin, Evans, GA (US); Donald Bruce Ogilvie, Aiken, SC (US); Sudhendra Venkatesh Hublikar, Martinez, GA (US)

(73) Assignee: AGY HOLDING CORP., Aiken, SC (US)

(21) Appl. No.: 13/213,428

(22) Filed: Aug. 19, 2011

Related U.S. Application Data
(60) Provisional application No. 61/379,758, filed on Sep. 3, 2010.

(51) Int. Cl. D03D 15/00; D01F 9/08; C09D 103/00; B32B 17/02

(52) U.S. Cl. 442/108; 428/378; 428/392; 524/47

(57) ABSTRACT

Embodiments of the present invention relate to sizing compositions, glass fibers, and fabrics. For example, some embodiments provide a composition that includes: (a) a cooked starch comprising fluid-swollen starch particles and (b) a film forming polymer. The film forming polymer, in some embodiments, has a glass transition temperature from about −50° C. to about 150° C. The fluid-swollen starch particles, in some embodiments, exhibit a granular swelling power (GSP) from about 1 to about 20.

### PRIORITY

This application claims priority to U.S. Provisional Application Ser. No. 61/379,758 entitled “SIZING COMPOSITION, GLASS STRAND, AND FABRIC,” filed Sep. 3, 2010, the contents of which are incorporated herein in their entirety.

### BACKGROUND

Typically, the surfaces of glass fibers are coated with a sizing composition during the forming process to protect the glass fibers from interfilament abrasion. As used herein, the term “size” or “sizing” means a sizing composition applied to glass fibers immediately after formation of the glass fibers. Sized or treated glass fibers are typically gathered into a strand, wound to form a forming package, and dried or cured and subjected to further processing such as twisting or roving. The strands must withstand rigorous processing conditions while maintaining various properties. Starch-oil sizing technology has traditionally been used to produce glass fiber strands, which are then converted into many different forms such as glass fabrics, coated yarns, non-woven scrim, etc. The advantage of starch-oil sizings is that the sizings facilitate conversion operations such as twisting and weaving because a strand of low integrity is typically produced. Low integrity allows the filaments of the strand to easily adjust to twisting and weaving forces. Also, low integrity allows the strand to be transported at low air pressures in air jet looms. Moreover, fabric produced using starch-oil sizing is thin and uniform because the individual fibers are more spread out. However, some disadvantages of starch-oil sizings are defects such as powder generation (due to sizing components getting abraded off the fiber surface) and higher than desired levels of broken filaments. Other sizing technologies, such as sizing systems that include film forming polymers, produce strands with high integrity and, therefore, low broken filament levels. An integral strand is undesirable in many applications, such as air jet weaving, because the strand is difficult to transport and the fabric produced from the strand by air jet weaving is relatively thick and has high fabric porosity. A thick, high porosity fabric is undesirable in circuit board applications, for example, because evenly distributed individual fibers are required to produce a very flat, smooth, and uniform fabric for the circuit board. Thus, there is a need to provide sizing compositions and strands that overcome these deficiencies in the prior art.

### SUMMARY OF SELECTED EMBODIMENTS OF THE PRESENT INVENTION

In general terms, embodiments of the present invention relate to sizing compositions, glass strands, glass yarns, and fabrics.

In some embodiments of the present invention, a sizing composition is provided that includes: (a) a cooked starch comprising fluid-swollen particles; and (b) a film forming polymer. In some embodiments, the film forming polymer has a glass transition temperature from about −50° C. to about 150° C.

In some embodiments of the present invention, a sizing composition is provided that includes: (a) a cooked starch comprising fluid-swollen particles having a granular swollen power (GSP) from about 1 to about 20; and (b) a film forming polymer having a glass transition temperature from about 0° C. to about 30° C. In some embodiments, the sizing composition further includes vinyl acetate ethylene copolymer.

In some embodiments of the present invention, a glass strand is provided that includes: (a) a sizing composition that includes a film forming polymer and a cooked starch that includes fluid-swollen particles; and (b) a plurality of glass fibers in contact with the sizing composition, the plurality of glass fibers have at least one gap formed between two or more of the plurality of glass fibers, where the fluid-swollen particles are positioned within the at least one gap.

In some embodiments of the present invention, a glass strand is provided that includes: (a) a sizing composition that includes a cooked starch and a film forming polymer; and (b) a plurality of glass fibers in contact with the sizing composition, where the strand exhibits an abrasion broken filament level under 300 broken filaments per pound (BF/lb). In some embodiments, the glass strand is configured to have an air jet broken filament level under 300 broken filaments per kilometer (BF/km). In some embodiments, the strand is configured to have a speed of greater than 3000 feet per minute (fpm) when subjected to an air jet.

In some embodiments of the present invention, a fabric is provided that includes: (a) a plurality of glass strands; and (b) a sizing composition that includes a cooked starch and a film forming polymer, where the plurality of glass strands exhibit an abrasion contact broken filament level under 300 broken filaments per pound (BF/lb).

### BRIEF DESCRIPTION OF THE DRAWINGS

Having thus described some embodiments of the present invention in general terms, reference will now be made to the accompanying drawings, wherein:

FIG. 1 is an exemplary glass fiber bundle in accordance with an embodiment of the present invention;

FIG. 2 is an illustration of exemplary portions of strands used in air jet weaving applications in accordance with an embodiment of the present invention;

FIG. 3 is a top plan view of a portion of a woven fabric in accordance with an embodiment of the present invention; and

FIG. 4 is an illustration of a strand abrasion test in accordance with an embodiment of the present invention.

### DESCRIPTION OF EMBODIMENTS OF THE PRESENT INVENTION

Embodiments of the present invention will now be described more fully hereinafter with reference to the accompanying drawings, in which some, but not all, embodiments of the present invention are shown. Indeed, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, or operational aspects of any of the embodiments described or contemplated herein may be included in any other embodiment of the present invention described or contemplated herein, or vice versa. In addition, where possible, any terms expressed in the singular form herein are meant to also include the plural form or vice versa, unless explicitly stated otherwise. Accordingly, the terms “a” or “an” shall mean “one or more,” even though the phrase “one or more” is also used herein. Like numbers refer to like elements throughout.

In order to facilitate an understanding of the various aspects of the sizing composition, glass strand, glass yarn, and fabric, the following are defined below.

The terms “fiber” or “filament” are used interchangeably herein and refer without limitation to a fine, threadlike piece of material such as glass.

The terms “strand” as used herein refers without limitation to any combination of a plurality of fibers or filaments. For example, a strand may include a yarn or a roving.

The term “yarn” as used herein refers without limitation to a collection of fibers or filaments that are twisted together to form a single unit.

The phrase “granular swelling power” or “GSP” as used herein refers without limitation to a measure of the ability of a starch to swell in water. For example, the GSP can be further defined by a value obtained by dividing the wet gel weight of a starch by the dry weight of that starch.

The phrase “fluid-swollen particles” as used herein refers to any swollen starch particles. For example, fluid-swollen particles can include starch particles that absorb water.

The phrase “cohesive strength” as used herein refers without limitation to the strength of a material to hold itself together. When referring to a material, “high cohesive strength” as used herein means that material is difficult to separate when subjected to a force. For example, in a strand with high cohesive strength, the glass fibers do not easily separate from one another when exposed to an air jet.

The term “integral” or “integrity” as used here refers without limitation to the degree of bonding of glass fibers to one another. For example, a glass fiber strand that is “highly integral” means that the glass fibers are bonded tightly together with little or no separation between the glass fibers.

The phrases “open strand” or “closed strand” as used herein refers without limitation to the degree of separation between glass fibers in a strand. For example, glass fibers of an “open strand” are separated by gaps positioned between two or more of the fibers. As another example, glass fibers of a “closed strand” have little or no separation between the glass fibers of the strand.

Disclosed herein are sizing compositions, glass fibers, glass yarns, and fabrics that have low broken filaments and very low powder formation, while at the same time, are capable of being transported with low air pressure, and create a thin, uniform fabric. More particularly, the sizing composition comprises a cooked starch comprising fluid-swollen particles and a film forming polymer.

### Starch

The sizing composition disclosed and described herein comprises a starch. In some embodiments, a cooked starch comprising fluid-swollen particles is provided. For example, a starch can be mixed with water and the mixture cooked at a certain temperature range (e.g., 130° F.-250° F.) until fluid-swollen particles are formed. Cooking times and temperatures for forming the fluid-swollen particles can vary. The starch forms fluid-swollen particles that swell, but do not burst or dissolve. For example, in some embodiments, the cooked starch has a granular swelling power (GSP) from about 1 to about 20, preferably, the cooked starch has a GSP from about 9 to about 17, and more preferably, the cooked starch has a GSP from about 9 to about 13. Various test methods are available to test the GSP of the cooked starch. For example, in one test method, each of two tubes are filled with 13 grams of cooked starch and centrifuged at 2500 rpm for 30 minutes. The liquid is poured out from the tubes and the weights of the gel remaining in each test tube are obtained. The gel is dried and the dry starch weight is obtained. The GSP is the division of the wet weight by the dry weight.

In some embodiments, the starch used in the sizing composition is not easily water soluble. In some embodiments, the starch used in the sizing composition may be a particulate starch that retains some granular structure such that there remain discrete particles after hydration. Particulate starches can be prepared by a number of techniques such as chemical crosslinking, physical modification, physical association, and/or hydration under controlled conditions.

Suitable starches for the subject sizing composition include any modified or unmodified starch derived from starch sources such as corn, wheat, potato, tapioca, cassava, waxy maize, sago, rice, hybrid starches, genetically modified starches, and combinations thereof. Examples of starches that may be used in the sizing composition include: oxidized starches; cationic starches such as amine modified starches; ester or ether modified starches such as acetate starch, starch phosphates, succinylated starch, hydroxyalkyl starch ethers, propylene oxide modified starch, and carboxymethyl starch; starch graft copolymers such as starch-graft-polyacrylamide and starch-graft-acrylonitrile; crosslinked starches such as NATIONAL™ 1554 commercially available from Celanese, Ltd., Dallas, Tex., di-starch phosphate, di-starch adipate, acetylated di-starch adipate, hydroxypropyl di-starch phosphate, and acetylated di-starch phosphate; unmodified high amylose corn starch (HYLON® V, HYLON® VII commercially available from Celanese, Ltd., Dallas, Tex.), and combinations thereof. Crosslinked starches may be formed by treatment of a starch with any number of crosslinking agents such as bifunctional etherifying and/or esterifying agents such as epichlorohydrin, bis-β-chloroethyl ether, dibasic organic acids, phosphates, phosphorus oxychloride, trimetaphosphate, and linear mixed anhydrides or acetic and di- or tribasic carboxylic acids.

In one embodiment, the cooked starch is present in the sizing composition in an amount from about 10 to about 90 weight percent on a total solids basis, preferably from about 46 to about 66 weight percent and, more preferably, from about 50 to about 62 weight percent.

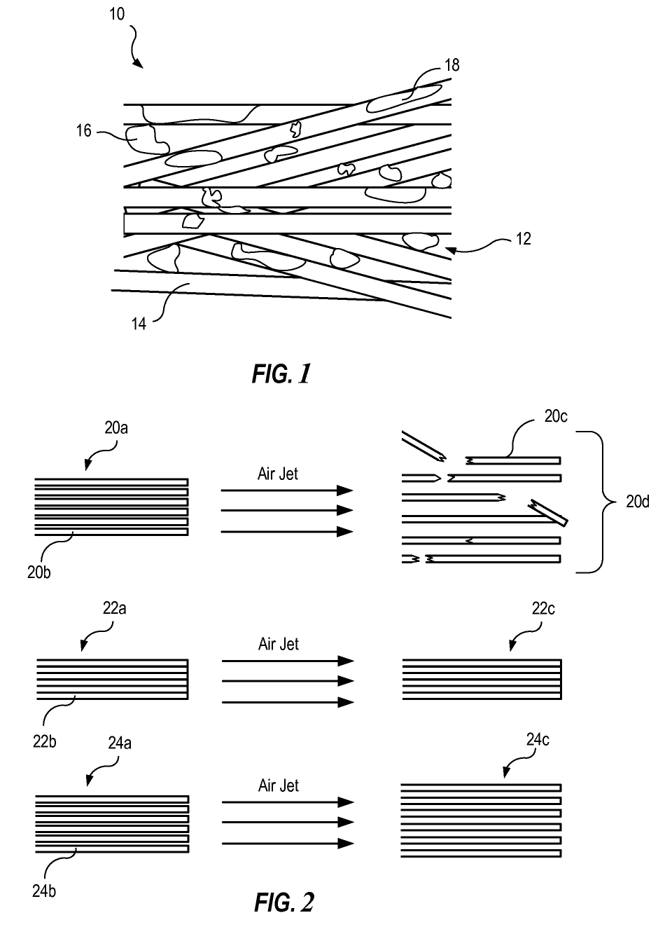

When provided in a sizing composition, the fluid-swollen particles of the cooked starch can be used to maintain an open strand. For example, depending on its thickness or weight, a strand can include dozens or hundreds of glass fibers. The fluid-swollen particles of the cooked starch, in some embodiments, are positioned in gaps formed between two or more of the glass fibers. The fluid-swollen particles help to keep the glass fibers separate and the strand open by maintaining the gaps formed between two or more of the glass fibers in the strand as described in more detail with regard to FIG. 1 below. For certain processes, such as air jet weaving, an open glass fiber strand is preferred.

### Film Forming Material

As disclosed and described herein, the sizing composition further includes a film forming material. The film forming material acts to bind the fibers together in a unit to give the fibers increased abrasion resistance during processing and handling. The sizing composition comprising the film forming material reduces broken filament levels.

In the processing of the fibers into a strand or the processing of strands into yarn, the twisting and winding operations can produce numerous broken filaments. These broken filaments tend to extend out of the strand or yarn and can adversely affect the quality of the fabric as well as the operation of a loom that uses such yarn. For example, broken filaments appearing in a cloth used in the production of printed circuit boards can produce small irregularities in the circuit board, which can result in short circuits between adjacent circuit layers. The film forming material of the sizing composition prevents the fibers from breaking as the fibers are subjected an air jet, twisted, or otherwise subjected to abrasion

Further, in some embodiments, the sizing composition can also reduce powder formation or build up around guide eyelets during processing. Powder formation results from release of starch particles or other components of the sizing composition from the glass fiber strand during processing. Additionally, in some embodiments, the film forming material used in the sizing composition provides the glass fibers with high cohesive strength. For example, in processing strands or yarn in air jet weaving applications, the strands are subject to air jets, which can cause the fibers to tear apart, resulting in broken filaments. In some embodiments, the sizing composition comprising the film forming material at least partially coats the fibers and holds the fibers together.

In some embodiments, the sizing composition comprises a film forming polymer. Suitable film forming polymers for use in the sizing composition include, but are not limited to: polyurethanes; polyepoxides, polyolefins such as polyethylene and polypropylene; polyesters; acrylics such as polyacrylate, polymethyl acrylate, and polymethyl methacrylate; vinyl acrylics; styrene acrylics; vinyl acetate ethylene copolymer; polyvinyl alcohol; polyvinyl pyrrolidone, N-vinyl amide polymers; vinyl chloride copolymers; vinyl acetate; styrene butadiene copolymers; butadiene-methyl methacrylate copolymer; styrene-butadiene-methyl methacrylate copolymer; styrene-vinyl acetate copolymer; acrylonitrile-butadiene copolymer; vinyl ester expoxide resin; and derivatives and combinations thereof.

In one embodiment, the polymer is present in the sizing composition in an amount from about 5 to about 80 weight percent on a total solids basis, preferably from about 8 to about 40 weight percent and, more preferably, from about 10 to about 25 weight percent.

In some embodiments, the glass transition temperature (Tg) of the film forming polymer can vary. For example, in some embodiments, the film forming polymer has a Tg from about −50° C. to about 150° C. In other embodiments, the film forming polymer has a Tg from about −40° C. to about 50° C. In still other embodiments, the film forming polymer has a Tg from about 0° C. to about 30° C. In another example, in some embodiments, the film forming polymer has a Tg from about 4° C. to about 20° C.

The sizing composition can further include one or more lubricants such as polyol esters; amide substituted polyethyleneamine; partially hydrogenated soybean oil; vegetable oils; hydrogenated vegetable oils, such as cotton seed oil, corn oil, and soybean oil; trimethylolpropane triesters; pentaerythritol; and derivatives and combinations thereof.

The sizing composition can further include one or more surfactants such as octylphenoxy poly(ethyleneoxy)ethanol, polyoxyethylene sorbitan monolaurate, and derivatives and combinations thereof.

Other additives that may be used in the sizing composition include antimicrobial agents such as 5-chloro-2-methyl-4-isothiazolin-3-one and 2-methyl-4-isothiazolin-3-one, diiododomethyl-p-tolylsulfone, benzene, 1-((diiodomethyl)sulfonyl)-4-methyl- and methylene-bis-thiocyanate; polyethylene glycol; solvents; plasticizers; and combinations thereof.

Referring now to FIG. 1, an exemplary glass strand 10 is provided, in accordance with an embodiment of the present invention. In the illustrated embodiment, the strand 10 includes a plurality of glass fibers 14. Although the fibers 14 are composed of glass in the illustrated embodiment, it is understood that the fibers may be composed of one or more other materials, such as polymers, cellulose, carbon, and combinations thereof. Glass fibers suitable for use in the present invention include those prepared from fiberizable glass compositions such as “E-glass,” “R-glass,” “A-glass,” “C-glass” “S-glass,”“T-glass,” “L-glass,” “ECR-glass,” and fluorine and boron-free derivatives thereof.

In the illustrated embodiments, one or more of the glass fibers 14 are in contact with a sizing composition comprising fluid-swollen starch particles 16 and a film forming polymer 18. For example, in some embodiments, the glass fibers 14 are at least partially coated with the sizing composition. The sizing composition can be applied to the glass fibers in a variety of conventional ways, for example, by dipping the glass fibers in a bath containing the composition, by spraying the sizing composition upon the glass fibers, or by contacting the glass fibers with an applicator such as a roller or belt applicator.

The amount of the size composition applied to the glass fibers can vary based upon such factors as the size and number of glass fibers. For a plurality of glass fibers, the amount of sizing composition applied to the fibers can be about 0.1 to about 4.0 weight percent of the total weight of the sized glass fibers

It will be understood that, in some embodiments, the starch particles 16 can include the film forming polymer 18 or other components of the sizing composition such as lubricants, surfactants, etc. For example, the starch particles 16 may be coated with the film forming polymer 18. It will be further understood that, in some embodiments, the film forming polymer 18 can include the starch particles 16 or other components of the sizing composition such as lubricants. For example, the film forming polymer 18 may further include lubricants and surfactants.

In some embodiments, one or more gaps 12 are formed between at least two of the fibers 14. For example, in some embodiments, the fluid-swollen starch particles 16 are positioned within the gaps 12. As another example, in some embodiments, the starch particles 16 are positioned on the fibers 14. As still another example, in some embodiments, the film forming polymer 18 can be in contact with the fibers 14 and positioned within the gaps 12. The fluid-swollen particles 16 separate the fibers 14 resulting in an open strand.

For certain processes, an open glass fiber strand is preferred. For example, in coated yarn applications where production of coated strands with a uniform round shape distribution is sought, an open strand is preferred. In coating processes that use a die, a round strand is compressed as it is pulled through a die after coating with materials such as plastisol, phthalate-based plasticizer, polyvinyl chloride, and combinations thereof. The open strand promotes penetration of the coating into the strand, and allows the fibers to easily take the shape of the die. Further, the sizing composition in contact with the fibers 14 also prevent or reduce broken filaments levels that can be caused by internal abrasion of the fibers 14, external abrasion, or the stretching or twisting of the strand 10.

Referring now to FIG. 2, exemplary portions of strands 20a, 22a, 24a used in an air jet weaving application is provided in accordance with an embodiment of the present invention. In air jet weaving applications, one or more air jets transfer the strand across the loom. The weft yarn is inserted into a warp shed formed by the warp yarn by a blast of compressed air from one or more air jet nozzles. The weft yarn is propelled across the width of the fabric by compressed air.

The glass strand 20a for use in the air jet loom includes a plurality of glass fibers 20b. As shown, the glass strand 20a is subject to an air jet resulting in a transferred glass strand 20d. The transferred glass strand 20d includes a plurality of broken filaments 20c. The application of the air jet to the strand 20a causes the fibers 20b of the strand to separate or break apart from one another. The separation of the fibers 20b can result in broken filaments 20c as illustrated in FIG. 2.

Also illustrated in FIG. 2 is the closed strand 22a. The closed strand 22a includes a plurality of glass fibers 22b. As shown, a transferred closed strand 22c is produced after the closed strand 22a passes through the air jet. The glass fibers 22b are bonded closely together such that when the closed strand 22a is subjected to the air jet, the closed strand 22a does not open up. Due to the integral nature of some glass fiber strands, such as the closed strand 22a, the air jet is not able to transfer such strands across the loom or will transfer the strands at low speeds. The resulting fabric will tend to be thick with high porosity.

Further illustrated in FIG. 2 is the open strand 24a. The open strand 24a includes a plurality of glass fibers 24b. The glass fibers 24b are at least partially coated with a sizing composition (not shown). The sizing composition includes fluid-swollen starch particles and a film forming polymer in accordance with some embodiments of the invention. The fluid-swollen particles may be positioned within gaps (not shown) formed between two or more of the glass fibers 24b of the open strand 24a. As shown, when the open strand 24a passes through the air jet, a transferred open strand 24c is produced. The glass fibers 24b of the open strand 24a open up when exposed to the air jet such that the strand is transferred across the loom at high speeds, however, the glass fibers 24b of the open strand 24a do not separate excessively so as to cause the fibers to break. High speed is desirable because it reduces manufacturing costs by allowing the looms to run faster. In addition, the fabrics produced with the open strand 24a will be thinner with lower porosity than fabrics produced with the closed strand 22a.

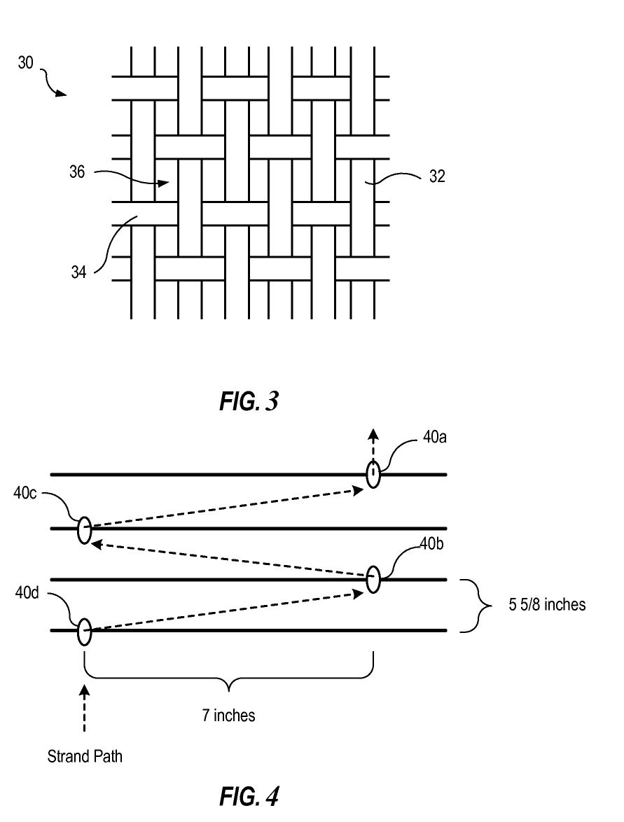

Referring now to FIG. 3, a portion of a woven fabric 30 in accordance with an embodiment is provided. The woven fabric 30 comprises a warp strand 32 and a weft strand 34. The strands 32, 34 comprise a plurality of glass fibers (e.g., the glass fibers 14 of FIG. 1). Positioned between the strand 32, 34 are open areas 36.

In the illustrated embodiment, the strands 32, 34 of fabric 30 are arranged in a plain weave pattern. However, it is understood that the fabric 30 may be arranged in other weaving patterns such as twill weave, broken twill weave, satin weave, etc. In the illustrated embodiment, one or more of the strands 32, 34 are at least partially coated with a sizing composition that includes fluid-swollen starch particles and a film forming polymer. The sizing composition results in a separation of the fibers in the strand such that the strands 32, 34 spread out and close the open areas 36 between the strands, resulting in a thin fabric with small open areas between the strands.

The strands 32, 34 can be used to prepare woven or non-woven fabrics, knitted products, braided products, laid scrim (Crenette), or other fabric forms not otherwise specified. Fabrics produced using the strands 32, 34 can be woven using any loom such as a shuttle loom, air jet loom, rapier loom, or other weaving machine, or the fabrics can be produced by knitting (circular, traditional, warp), beaming, or braiding. The fabric produced using strands 32, 34 can be used in a wide variety of applications, such as printed circuit boards, polytetrafluoroethylene (TEFLON®, DuPont Company) coated conveyor belting, cement board reinforcements, industrial sleeving, surf boards, roofing scrims, paper/foil lamination, filament tape, filtration fabrics, overwrap reinforcements for optical fiber cables, etc.

In some embodiments, the strands 32, 34 are at least partially coated with a secondary coating comprising plastisol, phthalate-based plasticizer, polyvinyl chloride, or combinations thereof to produce coated yarns. For example, in some embodiments, the secondary coating at least partially coats the strands 32, 34 and/or the sizing composition in contact with strands 32, 34. Fabrics using such coated yarns can be produced by typical fabric forming techniques that include, but are not limited to rapier loom weaving, shuttle loom weaving, and knitting (e.g., circular, traditional, or warp knit). The fabric produced using the strands 32, 34 coated with polyvinyl chloride plastisols can be used in many applications, which include, but are not limited to insect screens, solar screens, pool and patio enclosures, safety netting, curtains, decorative wall coverings, exterior furniture, cement board reinforcement, and tarps for covering loads such as those used by dump trucks.

### Test Methods

A. Strand Abrasion Test

Purpose: The purpose of this test is to evaluate and quantify the level of broken filaments generated as a result of being exposed to a series of contact points.

### Procedure:

1. Bobbins comprising the strand to be tested are loaded into a typical creel or other type of letoff stand. The strand is then fed through four ceramic eyelets 40a, 40b, 40c, 40d that are arranged in a zig-zag pattern as illustrated in FIG. 4. The input tension to this bank of eyelets is controlled using an appropriate tension device such as a whorl tensioner, which are commercially available from McCoy Ellison, Inc., Monroe, N.C., to give an input tension of 25 g when running at 1500 fpm.
2. After exiting the eyelet bank, the strands are run in front of a broken filament detection device such as the Fraytec MV sensors, which are commercially available from Fibrevision of Cheshire, England.
3. The strands are then wound on a spool using a winder, such as winders commercially available from Lessona of Burlington, N.C., USA.
4. Before starting the test, the eyelets are cleaned with isopropyl alcohol to remove any residual buildup from previous runs, and then the strand is run without collecting any data for approximately 0.3 lb of glass to eliminate the outer section of the bobbins from the testing. Once the test starts, it is run for 90 minutes at 1500 fpm, and the cumulative broken filament data is reported over a 30 minute period.
5. The data collected during the test include:
a. cumulative broken filament count for each 30 minute period is converted to BF/lb of glass run. The abrasion broken filament level is the average of the three data points;
b. input tension; and
c. tension at the output of the zig-zag eyelet bank.

In some embodiments, one or more strands in contact with the sizing composition have an abrasion broken filament level from about 0 BF/lb to about 300 BF/lb; preferably an abrasion broken filament level from about 0 BF/lb to about 100 BF/lb, more preferably an abrasion broken filament level from about 0 BF/lb to about 50 BF/lb, and most preferably an abrasion broken filament level from about 0 BF/lb to about 20 BF/lb.

B. Air Jet Simulation Test

Purpose: The purpose of this test is to evaluate and quantify the level of broken filaments generated as a result of being exposed to an air jet.

### Procedure:

1. A bobbin comprising the strand to be tested is placed on a scale capable of reading to a 0.01 g resolution.
2. The strand is then threaded through a filling accumulator, such as the Chrono X2 commercially available from IRO AB, Sweden with the brush removed, and then through a post and disc tensioning device. Then the strand is further threaded through an air jet device, such as the one used on a ZA103I Air Jet Loom commercially available from Tsudakoma, Corp., Nomachi, Kanazawa-shi, Japan Then, the strand is passed through a broken filament counter such as the Fraytec MV sensor commercially available from Fibrevision, Cheshire, England. Finally, the strand is passed through a venturi device that uses air to pull the strand forward.
3. Approximately 40 psi of air pressure is applied to the venturi device such that the strand just barely moves through the testing apparatus.
4. Air pressure is then increased to 50 psi such that the strand begins to run quickly through the apparatus. Simultaneously, the scale and broken filament counter are set to zero, and a stopwatch is started.
5. The test is allowed to run for 30 minutes, and then stopped.
6. The data collected during the test includes:
a. The weight of the strand run off;
b. The exact time the test was allowed to run to the nearest 0.1 second; and
c. The cumulative broken filament count.
7. From the above data, the following values are calculated:
a. strand speed in feet per minute (fpm), assuming nominal yield for the sample; and
b. broken filaments per kilometer (BF/km).

In some embodiments, one or more strands in contact with the sizing composition have an air jet broken filament level from about 0 BF/km to about 300 BF/km; preferably an air jet broken filament level from about 0 BF/km to about 100 BF/km, more preferably an air jet broken filament level from about 0 BF/km to about 50 BF/km, and most preferably an air jet broken filament level from about 0 BF/km to about 30 BF/km.

In some embodiments, one or more strands in contact with the sizing composition have a strand speed greater than 3,000 fpm, preferably a strand speed greater than 4,000 fpm, more preferably a strand speed greater than 5,000 fpm, and most preferably a strand speed of greater than 5,500 fpm.

The following are illustrative examples of sizing compositions and yarns prepared with the sizing composition.

### EXAMPLES

Sizing compositions, in accordance with some embodiments, were prepared as described below with reference to Table 1.

TABLE 1

| | Sample 1 | Sample 2 | Sample 3 |
|---|---|---|---|
| Component | (g) | (g) | (g) |
| Lubricant/surfactant Blend¹ | — | 506.6 | 506.6 |
| Octylphenoxy Poly(Ethyleneoxy)Ethanol² | 14.0 | — | — |
| Polyoxyethylene sorbitan monolaurate³ | 11.8 | — | — |
| Antimicrobial (8%)⁴ | 8.5 | 8.5 | 8.5 |
| Polyethylene glycol⁵ | — | 11.6 | 11.6 |
| Amide substituted polyethyleneamine⁶ | 45.2 | 45.1 | 45.1 |
| Polyol ester lubricant | 118.4 | — | — |
| Starch (5.25%)⁷ | 3624.4 | 5794.7 | 6519.1 |
| VAE (55%) (VINNAPAS ® 320)⁸ | 346.0 | — | — |
| VAE (55%) (VINNAPAS ® 410)⁹ | — | 138.3 | 69.1 |
| Water | 3331.7 | 995.3 | 340.1 |

| | Sample 4 | Sample 5 | Sample 6 |
|---|---|---|---|
| Component | (g) | (g) | (g) |
| Lubricant/surfactant Blend | — | 272.7 | 506.9 |
| Octylphenoxy Poly(Ethyleneoxy)Ethanol | 14.0 | 8.4 | — |
| Polyoxyethylene sorbitan monolaurate | 11.8 | 6.9 | — |
| Antimicrobial (8%) | 8.5 | 8.5 | 8.5 |
| Polyethylene glycol | — | — | 11.6 |
| Amide substituted polyethyleneamine | 45.2 | 45.2 | 45.2 |
| Polyol ester lubricant⁷ | 118.4 | 69.2 | — |
| Starch (5.25%) | 3624.4 | 3624.4 | 3624.4 |
| VAE (55%) (VINNAPAS ® 320) | — | — | 346.0 |
| VAE (55%) (VINNAPAS ® 410) | 346.0 | 346.0 | — |
| Water | 3331.7 | 3118.7 | 2957.3 |

| | Sample 7 | Sample 8 |
|---|---|---|
| Component | (g) | (g) |
| Lubricant/surfactant Blend | 506.6 | 506.9 |
| Octylphenoxy Poly(Ethyleneoxy)Ethanol | — | — |
| Polyoxyethylene sorbitan monolaurate | — | — |
| Antimicrobial (8%) | 8.5 | 8.5 |
| Polyethylene glycol | 11.6 | 11.6 |
| Amide substituted polyethyleneamine | 45.1 | 45.2 |
| Polyol ester lubricant⁷ | — | — |
| Starch (5.25%) | 5070.4 | 3624.4 |
| VAE (55%) (VINNAPAS ® 320) | 207.4 | — |
| VAE (55%) (VINNAPAS ® 410) | — | 346.0 |
| Water | 1650.5 | 2957.4 |

¹A blend of partially hydrogenated soybean oil; TRITON ® X-100, a octylphenoxypoly ethanol surfactant commercially available from Sigma-Aldrich, Inc., St. Louis, Missouri; and TWEEN ® 81, a polyoxyethylene sobritan monolaurate commercially available from Croda International Plc, East Yorkshire, U.K.
²IGEPAL ® CA 630 octyphenoxy poly(ethylenoxy)ethanol is commercially available from Rhodia, Inc., Cranbury, New Jersey, USA
³TWEEN ® 81 polyoxyethylene sobritan monolaurate is commercially available from Croda International Plc, East Yorkshire, U.K.
⁴SPECTRUS ™ NX1106 antimicrobial agent (5-chloro-2-methyl-4-isothiazolin-3-one and 2-methyl-4-isothiazolin-3-one) is commercially available from GE Water and Process Technologies Canada, Oakville, Ontario, Canada
⁵POGOL ® 300 polyethylene glycol is commercially available from Huntsman Corp., Woodlands, Texas, USA
⁶EMERY 6760 amide substituted polyethyleneamine lubricant is commercially available from Cognis, GmbH, Monheim, Germany.
⁷HYLON ® V unmodified high amylase corn starch is commercially available from Celanese, Ltd., Dallas, Texas
⁸VINNAPAS ® 320 vinyl acetate ethylene copolymer is commercially available from Wacker Chemie AG, Munich, Germany.
⁹VINNAPAS ® 410 vinyl acetate ethylene copolymer is commercially available from Wacker Chemie AG, Munich, Germany.

Samples 1-8 were prepared as follows:

1. A 5.25% cooked starch solution was prepared be adding 4108 g of starch to 48000 g of water, heating the mixture to 130° F., and then cooking at 228° F. The percent solids of the cooked starch was adjusted to 5.25% with water.
2. The remaining components, except the vinyl acetate ethylene copolymer (VAE), were combined and stirred.
3. The cooked starch of step 1 and the VAE were then combined with the mixture of step 2 and stirred.

Experimental ECD450 1/0 1.0Z yarn samples were produced for testing. The yarn samples were at least partially coated with Samples 1-8 listed in Table 1. Yarns 1-8 were tested and compared against ECD450 1/0 1.0Z 620-1 7636 (hereinafter 620-1) which is commercially available from AGY Holding Corp., Aiken, S.C.

The test results are illustrated in Table 2 below. Yarns 1-8 listed in Table 2 were treated with Samples 1-8 listed in Table 1, respectively.

TABLE 2

| Test | Yarn 1 | Yarn 2 | Yarn 3 |
|---|---|---|---|
| Abrasion BF Level (BF/lb¹) | 45 | 25 | 9 |
| Air Jet BF Level (BF/km²) | 41 | 57 | 104 |
| Strand speed (fpm³) | 5054 | 4712 | 4291 |
| Test | Yarn 4 | Yarn 5 | Yarn 6 |
| Abrasion BF Level (BF/lb¹) | 11 | 19 | 91 |
| Air Jet BF Level (BF/km²) | 48 | 65 | 29 |
| Strand speed (fpm³) | 3628 | 3115 | 5089 |

| Test | Yarn 7 | Yarn 8 | 620-1 |
|---|---|---|---|
| Abrasion BF Level (BF/lb¹) | 46 | 10 | 341 |
| Air Jet BF Level (BF/km²) | 26 | 42 | 49 |
| Strand speed (fpm³) | 5029 | 4056 | 4874 |

¹BF/lb = the number of broken filaments per pound run
²BF/km = the number of broken filaments per kilometer
³fpm = feet per minute

As can be seen from the data in Table 2, the present invention was used to produce sizings that significantly outperformed the control (620-1) product for abrasion broken filaments, while still maintaining good speed in the air jet test and good air jet broken filament levels

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A sizing composition comprising:
a cooked starch comprising fluid-swollen particles; and
a film forming polymer.

2. The sizing composition of claim 1, wherein the fluid-swollen particles exhibit a granular swelling power (GSP) from about 1 to about 20.

3. The sizing composition of claim 1, wherein the film forming polymer has a glass transition temperature (Tg) from about −50° C. to about 150° C.

4. The sizing composition of claim 1, wherein the film forming polymer has a glass transition temperature (Tg) from about −40° C. to about 50° C.

5. The sizing composition of claim 1, wherein the film forming polymer has a glass transition temperature (Tg) from about 0° C. to about 30° C.

6. The sizing composition of claim 1, wherein the film forming polymer comprises a compound selected from the group consisting of: vinyl acetate ethylene copolymer, polyurethanes, polyepoxides, polyolefins, vinyl chloride copolymers, polyesters, styrene butadiene copolymers, acrylics, and combinations thereof.

7. The sizing composition of claim 1, wherein the film forming polymer comprises vinyl acetate ethylene copolymer.

8. A sizing composition comprising:
a cooked starch comprising fluid-swollen particles having a granular swelling power (GSP) from about 1 to about 20; and
a film forming polymer having a glass transition temperature from about 0° C. to about 30° C.

9. A glass fiber strand comprising:
a sizing composition comprising a film forming polymer, and a cooked starch comprising fluid-swollen particles; and
a plurality of glass fibers in contact with the sizing composition, the plurality of glass fibers having at least one gap formed between two or more of the plurality of glass fibers, wherein the fluid-swollen particles are positioned within the at least one gap.

10. The glass strand of claim 9, wherein the plurality of glass fibers exhibit a high cohesive strength.

11. The glass strand of claim 9, wherein the fluid-swollen particles exhibit a granular swelling power (GSP) from about 1 to about 20.

12. The glass strand claim 9, wherein the film forming polymer has a glass transition temperature (Tg) from about −50° C. to about 150° C.

13. The glass strand of claim 9, wherein the film forming polymer has a glass transition temperature (Tg) from about −40° C. to about 50° C.

14. The glass strand of claim 9, wherein the film forming polymer has a glass transition temperature (Tg) from about 0° C. to about 30° C.

15. The glass strand of claim 9, wherein the film forming polymer is a compound selected from the group consisting of: vinyl acetate ethylene copolymer, polyurethanes, polyepoxides, polyolefins, vinyl chloride copolymers, polyesters, styrene butadiene copolymers, acrylics, and combinations thereof.

16. The glass strand of claim 9, wherein the film forming polymer comprises vinyl acetate ethylene copolymer.

17. A glass fiber strand comprising:
a sizing composition comprising a cooked starch and a film forming polymer; and
a plurality of glass fibers in contact with the sizing composition, wherein the strand exhibits an abrasion broken filament level under 300 broken filaments per pound (BF/lb).

18. The strand of claim 17, wherein the strand is configured to have an air jet broken filament level of under 300 BF/km.

19. The strand of claim 17, wherein the strand is configured to have a speed of greater than 3000 feet per minute (fpm) when subjected to an air jet.

20. The strand of claim 17, wherein the plurality of glass fibers has at least one gap formed between two or more of the plurality of glass fibers.

21. The strand of claim 20, wherein the cooked starch comprises fluid-swollen starch particles positioned within the at least one gap.

22. A fabric comprising:
a plurality of glass strands; and
a sizing composition in contact with the plurality of glass strands, the sizing composition comprising a cooked starch and a film forming polymer, wherein the plurality of glass strands exhibit an abrasion broken filament level under 300 broken filaments per pound (BF/lb).

23. The fabric of claim 22, further comprising a secondary coating comprising a plasticizer and polyvinyl chloride, wherein the secondary coating at least partially coats the plurality of glass strands.

24. The fabric of claim 22, wherein the fabric is produced by a fabric producing technique selected from the group consisting air jet loom weaving, rapier loom weaving, shuttle loom weaving, knitting, beaming, braiding, and combinations thereof.
